(19) United States
(12) Patent Application Publication
(10) Pub. No.: US 2024/0236740 A1
(43) Pub. Date: Jul. 11, 2024

(54) GAP EXECUTION METHOD AND APPARATUS AND TERMINAL

(71) Applicant: VIVO MOBILE COMMUNICATION CO., LTD., Guangdong (CN)

(72) Inventors: Xuanbing LIU, Guangdong (CN); Xiaodong YANG, Guangdong (CN); Wei BAO, Guangdong (CN); Wenjuan PU, Guangdong (CN)

(21) Appl. No.: 18/417,475

(22) Filed: Jan. 19, 2024

Related U.S. Application Data
(63) Continuation of application No. PCT/CN2022/106987, filed on Jul. 21, 2022.

(30) Foreign Application Priority Data
Jul. 21, 2021 (CN) 202110826028.0

(51) Int. Cl. H04W 24/10

(52) U.S. Cl. CPC H04W 24/10

(57) ABSTRACT

The present application discloses a gap execution method and apparatus and a terminal, which belongs to the field of wireless communication technology. The gap execution method in the embodiment of the present application includes: in a case that a first gap overlaps a second gap or a measurement occasion corresponding to a first task, performing, by a terminal device, first processing on the first gap; where the terminal device is configured with at least one gap, the first gap and the second gap belong to the at least one gap, and the first processing includes ignoring the first gap or using the first gap.

### CROSS-REFERENCE TO RELATED APPLICATIONS

The present invention is a continuation application of PCT Application No. PCT/CN2022/106987 filed on Jul. 21, 2022, which claims priority to Chinese Patent application Ser. No. 20/211,0826028.0, filed with the China National Intellectual Property Administration on Jul. 21, 2021, and entitled “GAP EXECUTION METHOD AND APPARATUS AND TERMINAL”, the disclosures of which are incorporated herein by reference in their entireties.

### TECHNICAL FIELD

The present application belongs to the field of wireless communication technology, and specifically relates to a gap execution method and apparatus and a terminal.

### BACKGROUND

In related technology, the network side can configure multiple gap patterns for a terminal, and the terminal can use a corresponding gap to perform a corresponding task. For example, the network side configures a measurement gap for a terminal device (User Equipment, UE, which can also be called a terminal or a user terminal). The UE can use this measurement gap to perform inter-frequency measurements (IFM) and inter-radio access technology measurements (Inter-RAT Measurements), etc.

However, once a gap configured for the UE on the network side overlaps or conflicts with another gap, etc., problems such as ambiguous terminal behavior occur, affecting wireless communication performance.

### SUMMARY

According to a first aspect, a gap execution method is provided, including: in a case that a first gap overlaps with a second gap or a measurement occasion corresponding to a first task, performing, by the terminal device, first processing on the first gap; where the terminal device is configured with at least one gap, the first gap and the second gap belong to the at least one gap, and the first processing includes ignoring the first gap or using the first gap.

According to a second aspect, a gap execution apparatus is provided, applied to a terminal device. The apparatus includes: a first execution module, configured to: in a case that a first gap overlaps with a second gap or a measurement occasion corresponding to a first task, perform first processing on the first gap; where the terminal device is configured with at least one gap, the first gap and the second gap belong to the at least one gap, and the first processing includes ignoring the first gap or using the first gap.

According to a third aspect, a terminal is provided, where the terminal includes a 10 processor, a memory, and a program or an instruction stored in the memory and executable on the processor, where when the program or instruction is executed by the processor, steps of the method according to the first aspect are implemented.

According to a fourth aspect, a terminal is provided. The terminal includes a processor and a communications interface, the communications interface is coupled to the processor, and the processor is configured to run a program or an instruction to implement steps of the method according to the first aspect.

According to a fifth aspect, a gap execution method is provided, including: in a case that a first gap overlaps a second gap, ignoring, by a network side device, the first gap; where the first gap and the second gap are gaps configured by the network side device for a terminal device.

According to a sixth aspect, a gap execution apparatus is provided, applied to a network side device. The apparatus includes: a second execution module, configured to: in a case that a first gap overlaps a second gap, ignore the first gap; where the first gap and the second gap are gaps configured by the network side device for a terminal device.

According to a seventh aspect, a terminal is provided. The terminal includes a processor, a memory, and a program or an instruction that is stored in the memory and that can be run on the processor, where when the program or the instruction is executed by the processor, the step of the method according to the fifth aspect is implemented.

According to an eighth aspect, a network side device is provided. The network side device includes a processor and a communications interface, the communications interface is coupled to the processor, and the processor is configured to run a program or an instruction to implement step of the method according to the fifth aspect.

According to a ninth aspect, a readable storage medium is provided. The readable storage medium stores a program or an instruction, and when the program or the instruction is executed by a processor, the step of the method according to the first aspect or the fifth aspect is performed.

According to a tenth aspect, a chip is provided. The chip includes a processor and a communication interface. The communication interface is coupled to the processor. The processor is configured to run programs or instructions to implement step of the method according to the first aspect or the fifth aspect.

According to an eleventh aspect, a computer program product/program product is provided, the computer program/program product is stored in a non-volatile storage medium, and the program/program product is executed by at least one processor to implement the step of the method according to the first aspect or the fifth aspect.

### BRIEF DESCRIPTION OF DRAWINGS

FIG. 1 is a schematic structural diagram of a wireless communication system provided by an exemplary embodiment of the present application;

FIG. 2 is a schematic flowchart of a gap execution method provided by an exemplary embodiment of the present application;

FIG. 3 is a schematic flowchart of a gap execution method provided by another exemplary embodiment of the present application;

FIG. 4 is a schematic flowchart of a gap execution method provided by still another exemplary embodiment of the present application;

FIG. 5 is a schematic flowchart of a gap execution method provided by still another exemplary embodiment of the present application;

FIG. 6 is a schematic structural diagram of a gap execution apparatus provided by an exemplary embodiment of the present application;

FIG. 7 is a schematic structural diagram of a gap execution apparatus provided by another exemplary embodiment of the present application;

FIG. 8 is a schematic structural diagram of a terminal provided by an example embodiment of this application; and

FIG. 9 is a schematic structural diagram of a network side device provided by an example embodiment of this application.

### DESCRIPTION OF EMBODIMENTS

The following clearly describes technical solutions in embodiments of this application with reference to accompanying drawings in the embodiments of this application. Apparently, the described embodiments are some but not all of the embodiments of this application. All other embodiments obtained by a person of ordinary skill in the art based on the embodiments of this application shall fall within the protection scope of this application.

The terms “first”, “second”, and the like in this specification and claims of this application are used to distinguish between similar objects instead of describing a specific order or sequence. It should be understood that, the terms used in such a way is interchangeable in proper circumstances, so that the embodiments of this application can be implemented in an order other than the order illustrated or described herein. Objects classified by “first” and “second” are usually of a same type, and the number of objects is not limited. For example, there may be one or more first objects. In addition, in the description and the claims, “and/or” represents at least one of connected objects, and a character “/” generally represents an “or” relationship between associated objects.

It should be noted that, the technologies described in the embodiments of this application are not limited to a Long Term Evolution (LTE)/LTE-Advanced (LTE-A) system, and can also be used in other wireless communication systems such as Code Division Multiple Access (CDMA), Time Division Multiple Access (TDMA), Frequency Division Multiple Access (FDMA), Orthogonal Frequency Division Multiple Access (OFDMA), Single-carrier Frequency-Division Multiple Access (SC-FDMA), and another system. The terms “system” and “network” in the embodiments of this application may be used interchangeably. The technologies described can be applied to both the systems and the radio technologies mentioned above as well as to other systems and radio technologies. The following descriptions describe a new radio (NR) system for example purposes, and NR terms are used in most of the following descriptions, but these technologies can also be applied to an application other than an NR system application, for example, a 6th generation (6G) communications system.

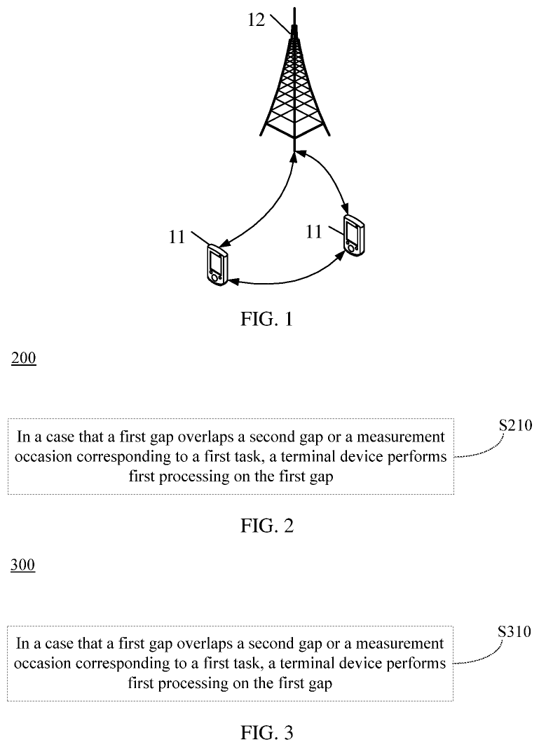

FIG. 1 is a schematic structural diagram of a wireless communications system to which an embodiment of this application can be applied. The wireless communications system includes a terminal 11 and a network side device 12. The terminal 11 may be a mobile phone, a tablet personal computer, a laptop computer or a notebook computer, a personal digital Assistant (PDA), a palmtop computer, a netbook, an ultra-mobile personal computer (UMPC), a mobile Internet device (MID), a wearable device or a vehicle-mounted device (VUE), a pedestrian terminal (PUE), and other terminal side devices. The wearable device includes: smart watches, bracelets, earphones, glasses, etc. It should be noted that a specific type of the terminal 11 is not limited in the embodiments of this application. The network side device 12 may be a base station or a core network. The base station may be referred to as a node B, an evolved node B, an access point, a base transceiver station (BTS), a radio base station, a radio transceiver, a basic service set (BSS), an extended service set (ESS), a node B, an evolved node B (eNB), a home node B, a home evolved node B, a wireless local area network (WLAN) access point, a WiFi node, a transmitting receiving point (TRP), or other appropriate terms in the art. As long as a same technical effect is achieved, the base station is not limited to a specified technical term. It should be noted that, in embodiments of the present application, only a base station in the NR system is used as an example, but a specific type of the base station is not limited.

The technical solutions provided by the embodiments of the present application will be described in detail below with reference to the accompanying drawings through some embodiments and their application scenarios.

It should be noted that the terminal device mentioned in this application can be a single-card terminal or a multi-card terminal, and there is no restriction on this.

As shown in FIG. 2, a schematic flowchart of a gap execution method 200 is provided in an exemplary embodiment of the present application. The method 200 can be executed by a terminal device, but is not limited thereto. Specifically, the method can be executed by hardware and/or software installed in the terminal device. In this embodiment, the method 200 may include at least the following step.

S210: In a case that a first gap overlaps a second gap or a measurement occasion corresponding to a first task, a terminal device performs first processing on the first gap.

The terminal device is configured with at least one gap (also called interval). In this embodiment, the at least one gap may be configured by the network side device in a connected state, and the terminal device performs corresponding tasks based on the at least one gap, such as paging monitoring tasks, reference signal measurement tasks or other multi-card tasks.

Alternatively, the network side device can also configure at least one gap pattern for the terminal device. The gap pattern can include at least one gap, and the terminal device can perform a corresponding task based on at least one gap included in the gap pattern. Among them, the gap pattern may include a periodic gap pattern and an aperiodic gap pattern. The periodic gap pattern can contain multiple gaps, and the aperiodic gap pattern can contain one gap.

The first gap and the second gap belong to the at least one gap. In addition, the first gap and the second gap or the measurement occasion corresponding to the first task may be of equal or unequal length, and are not limited here.

The aforementioned “overlap” can be understood as partial overlap or complete overlap in the time domain, where “complete overlap” can be understood as one gap covering another gap, or a measurement occasion covering a gap, etc., or a gap covering a measurement occasion.

The first processing includes ignoring the first gap or using the first gap. “Ignoring the first gap” can be understood as: not using the first gap, not executing the first gap, not executing a task corresponding to a gap purpose during the first gap, being able to perform sending and receiving operations with the network side device during the first gap, releasing the configuration of the first gap, etc.

Correspondingly, “using the first gap” can be understood as: executing the first gap, executing a task corresponding to the gap purpose during the first gap, not being able to perform sending and receiving operations with the network side device during the first gap, etc.

Based on this, as a possible implementation, when the terminal device ignores the first gap, the terminal device can only ignore the fourth gap. The fourth gap is the first gap that overlaps the second gap or the measurement occasion corresponding to the first task, or the fourth gap is the first gap when the first condition is met. That is, the terminal device can only ignore all or part of the first gap where overlap or conflict occurs.

Alternatively, the terminal device may ignore the fourth gap and at least one first gap located after the fourth gap. For example, the terminal device can ignore the first gap that appears within a specified period of time. For another example, the terminal ignores all first gaps that may appear (that is, releases the configuration information corresponding to the first gap).

For example, it is assumed that the first gap that overlaps with the second gap or the measurement occasion corresponding to the first task is recorded as A, and the first gap that may appear after A is recorded as B, C, D, E, and F (in a chronological order). In this case, when the terminal device ignores the first gap, the terminal device can only ignore gap A, or can ignore gap A and gap B and C that appear in the specified period of time, or can ignore gap A and all B, C, D, E and F that may appear. This embodiment does not limit this.

In this embodiment, in the case that the first gap overlaps the second gap or the measurement occasion corresponding to the first task, the terminal device uses the first gap or ignores the first gap, thereby providing a gap processing mechanism in the scenario where gaps overlap each other or a gap overlaps the measurement occasion corresponding to the first task. This enables the terminal device to clarify its own behavior and perform gap processing, effectively ensuring the quality of wireless communication.

It should be noted that in this embodiment and subsequent embodiments, processing rules for the terminal device to perform the first processing on the first gap (such as rules for using the first gap and ignoring the first gap) may be determined through negotiation between the terminal device and the network side device, or can be agreed through protocol, or can be configured by the high layer or the network side, thereby maintaining information consistency between the network side device and the terminal device and avoiding problems such as data loss, thereby maintaining the connection between the terminal device and the network side device, and ensuring service continuity on the terminal device and improving user experience.

As shown in FIG. 3, a schematic flowchart of a gap execution method 300 is provided in an exemplary embodiment of the present application. The method 300 can be executed by a terminal device, but is not limited thereto. Specifically, the method can be executed by hardware and/or software installed in the terminal device. In this embodiment, the method 300 may include at least the following step.

S310: In a case that a first gap overlaps a second gap or a measurement occasion corresponding to a first task, a terminal device performs first processing on the first gap.

The terminal device is configured with at least one gap, the first gap and the second gap belong to the at least one gap, and the first processing includes ignoring the first gap or using the first gap.

It can be understood that for the implementation process of S310, in addition to referring to the relevant description in the method embodiment 200, as a possible implementation, in different scenarios, the terminal device may use the first gap or ignore the first gap in different manners, which is explained below with different examples.

### EXAMPLE 1

When the scenario is that the first gap overlaps the second gap, that is, when the first gap overlaps the second gap, that the terminal device uses the first gap can include any one of the following (11) to (16).
(11) Use the first gap and ignore the second gap

In an implementation, when the first gap has a specified length, a specified type (such as a measurement gap) or has specified purpose information (for paging monitoring or the like), if the first gap overlaps the second gap, the terminal may use the first gap by default and ignore the second gap.

Alternatively, the terminal device may not consider the type, length, purpose, or the like of the first gap. Once the first gap overlaps the second gap, the terminal uses the first gap and ignores the second gap by default.

In addition, in another implementation, the terminal device may use the first gap and ignore the second gap when at least one of the following (a) to (d) is met. (a) The first gap has a higher priority than the second gap.

The priority of the first gap can be determined by the terminal device or the network side device according to one or more of the length of the gap, the start time of the gap, the end time of the gap, the purpose information of the gap (such as a paging and connection process), and the like. There are no restrictions here.

For example, a long gap has a higher priority than a short gap; for another example, a gap with an early start time has a higher priority than a gap with a later start time.
(b) Destination information of the first gap has a higher priority than destination information of the second gap.

The priority of the purpose information can be agreed through protocol or the like. For example, it can be agreed that the priority of the paging purpose and/or the link connection purpose is high priority (High Priority Purpose), the priority of the measurement purpose can be low priority, or the paging purpose has a higher priority than the measurement purpose.
(c) A length of the first gap is longer than a length of the second gap.

That is, the priority of a long gap is higher than the priority of a short gap.
(d) A start time of the first gap is earlier than a start time of the second gap.

That is, a gap with an earlier start time has a higher priority than a gap with a later start time.

For example, based on (d), assuming that the first gap partially overlaps the second gap, the terminal device uses the first gap with an earlier start time and ignores the second gap.

It should be noted that “ignoring the second gap” described in this embodiment may mean ignoring the entire second gap, or may also mean ignoring part of the second gap.

For example, assuming that the start time of the first gap is 0 ms and the end time is 40 ms, and the start time of the second gap is 30 ms and the end time is 50 ms, the terminal device can ignore the entire second gap, that is, [30-50]ms, and during the first gap (that is, [0-40]ms), the terminal device performs the task corresponding to the first gap.

For another example, assuming that the start time of the first gap is 0 ms and the end time is 40 ms, and the start time of the second gap is 30 ms and the end time is 50 ms, the terminal device can ignore [30-40]ms in the second gap, and during [30-40]ms, the terminal device performs the task corresponding to the first gap, and during [30-50]ms, the terminal device performs the task corresponding to the second gap.

In this embodiment, the terminal device may determine the processing of the first gap based on at least one of (a) to (d). For example, the first gap can be used and the second gap can be ignored when (a) to (d) are satisfied at the same time. For another example, the first gap can be used and the second gap can be ignored when (a) and (b) are satisfied at the same time. For another example, the first gap can be used and the second gap can be ignored when (a), (b) and (d) are satisfied at the same time. There is no restriction here.
(12) Use the first gap and use the second gap after the first gap ends.

Assuming that the first gap partially overlaps the second gap, the terminal device can use the first gap first and delay the use of the second gap.

For example, assuming that the first gap is a measurement gap and the second gap is a one-time multi-SIM gap, the terminal device can use the measurement gap first, and then continue to use the one-time Multi-SIM gap after the measurement gap ends.
(13) Use the first gap and use the second gap before the first gap begins.

The second gap can be used within X (greater than or equal to 1) time units before the start of the first gap, and the first gap can be used after the second gap ends. Optionally, the time unit may be a time slot, a symbol, a subframe, etc.
(14) Use a third gap and use the second gap, where the third gap is a portion of the first gap that does not overlap the second gap.

When using the third gap and the second gap, a gap in the first gap other than the third gap are simultaneously ignored.
(15) Use the second gap within the first duration and use the first gap within the second duration; where the first duration includes a first number of time units that are earlier in the first gap, and the second duration includes time units in the first gap other than the first number of time units.
(16) Use the second gap within a third duration and use the first gap within a fourth duration, where the third duration includes a second number of time units that are later in the first gap, and the fourth duration includes time units in the first gap other than the second number of time units.

In (15) and (16), the first number and the second number can be agreed through protocol, or configured through high-layer signaling or the network layer, and the time unit can include time slot, symbol, subframe, etc.

### Example 2

When the scenario is that the first gap overlaps the second gap, that is, when the first gap overlaps the second gap and at least one of the following (21) to (25) is satisfied, the terminal device ignores the first gap.
(21) The terminal device ignores the first gap.

The length, type, purpose information, etc. of the first gap may not be considered. Once the first gap overlaps the second gap, the terminal device ignores the first gap by default. That is, if the first gap overlaps the second gap, the terminal may use the first gap and ignore the second gap by default.

Alternatively, when the length, type, purpose of the first gap are a specified length, a specified type, and a specified purpose, once the first gap overlaps the second gap, the terminal device may ignore the first gap by default.
(22) A length of the first gap is shorter than a length of the second gap.

It can be understood that the priority of a long gap is higher than that of a short gap.
(23) A start time of the first gap is later than a start time of the second gap.

It can be understood that a gap with an earlier start time has a higher priority than a gap with a later start time.
(24) Destination information of the first gap has a lower priority than destination information of the second gap.
(25) The first gap has a lower priority than the second gap.

For the implementation process of (22) to (25), refer to the relevant description in (11) above. To avoid repetition, they will not be described again here.

### Example 3

When the scenario is that the first gap overlaps the measurement occasion corresponding to the first task, that, when the first gap overlaps the measurement occasion corresponding to the first task, that the terminal device uses the first gap includes any one of the following (31) to (33).
(31) Use the first gap and ignore the first task.

The first task may include a radio resource management (RRM) measurement task, etc., and the measurement occasion or window used to perform the RRM measurement task may be called an RRM measurement timing configuration (SMTC) window or an SMTC measurement occasion or an RRM measurement occasion, or the like based on a synchronization signal and PBCH block (SSB).

Based on this, during the first gap, an RRM measurement task needs to be executed. Then, the terminal device uses the first gap, ignores the SMTC measurement window corresponding to the first task, or ignores the RRM measurement occasion corresponding to the first task by default.

In this embodiment, the RRM measurement task may include a measurement task of a serving cell, an inter-frequency measurement task, an inter-RAT measurement task, or the like; the corresponding SMTC measurement window may be an intra-frequency SMTC window, an inter-frequency SMTC window, or the like. There are no restrictions here.
(32) Use the first gap and execute the first task after the first gap ends.

That is, the terminal device can perform the first task, such as RRM measurement, after using the first gap. For example, for a multi-card terminal, the task on the first gap may include that the UE leaves a current network to perform a multi-card task. Based on this, after the first gap begins, the UE may leave the current network to perform the task on the first gap, and after completing the target task, return to the current network to perform RRM measurement. This operation can be performed during the first gap or after the first gap.
(33) using the first gap and executing the first task before the first task begins.

That is, the terminal device can perform the first task, such as RRM measurement, before using the first gap. For example, for a multi-card terminal, the task on the first gap may include that the UE leaves the current network to perform the multi-card task. Based on this, before the first gap begins, the RRM measurement task is performed, and then the UE can leave the current network to perform the task on the first gap. The operation can be performed during the first gap or before or after the first gap.

It should be noted that: after the first gap ends and before the first gap begins described in (32) and (33) can also be understood as after the terminal device performs the task on the first gap or before the task on the first gap begins. There is no restriction on this.

It should be noted that in the examples 1 to 3, in a case that the first task is an RRM measurement task and/or a measurement gap is ignored, a measurement period corresponding to the RRM measurement task is a first length, the first length is obtained by extending a length of the measurement period by a length of at least one first gap, and the measurement gap is associated with a measurement occasion corresponding to the RRM measurement task.

For example, assuming that one measurement period includes multiple measurement occasions that can be used for RRM measurement tasks, and the measurement gap is a gap configured by the network side device for the terminal device to perform the RRM measurement task, that is, a measurement gap can correspond to the measurement occasion of an RRM measurement task.

Based on this, the terminal device may ignore the measurement gap or measurement occasion.

### Example 4

In addition to the aforementioned scenarios, when the scenario is at least one of the following (41) to (48), that is, when the first condition is met, the terminal device may also perform the step of ignoring the first gap, where the first condition includes at least one of the following (41) to (48).
(41) Master cell group (MCG) radio link failure (RLF).

Corresponding to an MCG, the first gap may be a gap corresponding to the MCG. That is, in the case of the MCG radio link failure, the terminal device ignores the gap corresponding to the MCG.
(42) Secondary Cell Group (SCG) radio link failure.

Corresponding to an SCG, the first gap may be a gap corresponding to the SCG. That is, in the case of the SCG radio link failure, the terminal device ignores the gap corresponding to the SCG, or the terminal device ignores the gap corresponding to the SCG and the gap corresponding to the MCG.
(43) a first timer starts running, where the first timer is configured to monitor whether a radio link fails.

Optionally, the first timer may be T310 and/or T312.

Based on this, after T310 is turned on, the terminal device can ignore the first gap that may appear during the operation of T310, such as the gap corresponding to MCG and/or SCG. Correspondingly, during the first gap of T310 operation, the terminal device can also perform radio link monitoring.

Alternatively, after T312 is turned on, the terminal device can ignore the first gap that may appear during the operation of T312, such as the gap corresponding to MCG and/or

SCG. Correspondingly, during the first gap of T312 operation, the terminal device can also perform radio link monitoring.
(44) the terminal device sends a first message, where the first message includes at least one of an MCG failure message, an SCG failure message and a first indication message, and the first indication message is used to indicate to the network side device that the terminal ignores the first gap.

In the case that the first message is an MCG failure message, the terminal device may ignore the first gap and initiate fast MCG recovery after sending the MCG failure message (that is, initiating the MCG failure information reporting process).

In the case that the first message is an SCG failure message, the terminal device may ignore the first gap and initiate fast SCG recovery after sending the SCG failure message (that initiating the SCG failure information reporting process).

In the case that the first message is a first indication message, the terminal device ignores the first gap after sending the first indication message. The first indication message may carry information about at least one ignored gap, such as the name, type, whether the gap is periodic, and purpose information.

Corresponding to the terminal device, after receiving the first message sent by the terminal device, the network side device may also ignore the possible first gap according to the first message, or ignore possible corresponding gaps according to gap information carried in the first message, and there are no restrictions here.

In an implementation, the first message may be transmitted through radio resource control (RRC) signaling, which is not limited here.
(45) The terminal device initiates the MCG failure information process.

That is, when/after the MCG failure information process is triggered, the terminal device can ignore the first gap corresponding to the MCG.

Correspondingly, after receiving the MCG failure information message, the network side device ignores the corresponding first gap.
(46) The terminal device initiates the SCG failure information process. That is, when/after the SCG failure information process is triggered, the terminal device can ignore the first gap corresponding to SCG and MCG.

Correspondingly, after receiving the SCG failure information message, the network side device ignores the corresponding first gap.
(47) The terminal device sends a measurement report message.

As an implementation, the terminal device may ignore the first gap within a fifth duration after sending the measurement report message.

In this embodiment, the fifth duration may be agreed through protocol or indicated through high-layer signaling or configured by the network.

In addition, the fifth duration may also be determined based on the running duration of T312. For example, assuming that the terminal device sends a measurement report message and T312 is within running duration or starts running, the terminal may ignore the first gap during running of T312 or after T312 times out.

Correspondingly, after receiving the measurement report message, the network side device ignores the first gap.
(48) The overlap ratio between the first gap and the second gap exceeds a specific threshold.

For example, if the proportion of the first gap occupied by the second gap exceeds 50%, the remaining part of the first gap may not be enough to perform the task corresponding to the purpose of the first gap. Therefore, the terminal device ignores the first gap.

Optionally, the specific threshold may be agreed through protocol or indicated through high-layer signaling or configured by the network.

In this embodiment, the method for the terminal device to process the first gap is further provided in different scenarios, such as the priority mechanism when gaps overlap, the conflict handling mechanism for gap duration and RRM measurement, and the gap-ignoring mechanism in radio link failure scenarios, which effectively solves the conflict between multi-card gaps (such as the first gap) and existing measurement mechanisms and radio link failure processes, further ensuring wireless communication performance and service continuity on terminal devices, and improving user experience.

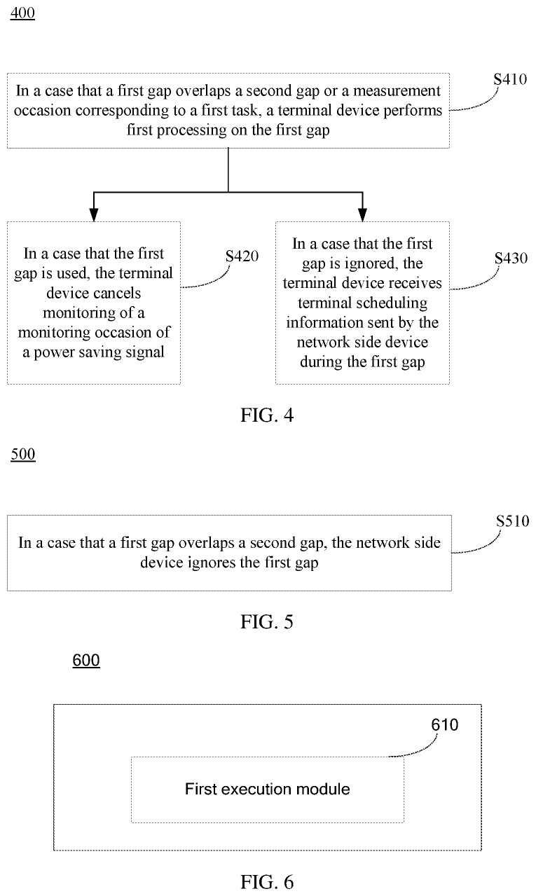

As shown in FIG. 4, a schematic flowchart of a gap execution method 400 is provided in an exemplary embodiment of the present application. The method 400 can be executed by a terminal device, but is not limited thereto. Specifically, the method can be executed by hardware and/or software installed in the terminal device. In this embodiment, the method 400 may include at least the following step.

S410: In a case that a first gap overlaps a second gap or a measurement occasion corresponding to a first task, a terminal device performs first processing on the first gap.

The terminal device is configured with at least one gap, the first gap and the second gap belong to the at least one gap, and the first processing includes ignoring the first gap or using the first gap.

It can be understood that for the implementation process of S410, reference can be made to the relevant descriptions in method embodiments 200 and 300. To avoid duplication, the details are not repeated here.
S420: In a case that the first gap is used, the terminal device cancels monitoring of a monitoring occasion of a power saving signal.

That is, the terminal device does not monitor a power saving signal or a monitoring occasion of the power saving signal that appears during the first gap.

Optionally, the power saving signal at least includes a DCP (DCI with CRC scrambled by PS-RNTI) signal and/or a wake up signal (WUS).

S430: In a case that the first gap is ignored, the terminal device receives terminal scheduling information sent by the network side device during the first gap.

That is, during the ignored first gap, normal data transmission and reception can be performed between the network side device and the terminal device, for example, the network side device sends RRC reconfiguration information to the terminal device to ensure normal transmission of data. It can be understood that it is assumed that the first gap is configured to perform task A, but due to gap overlap and other issues, the first gap is ignored, that is, task A is not performed. In this case, the network side device can still perform data transmission and reception with the terminal during the first gap.

Optionally, the manner in which the network side device schedules the terminal device may include the following (1) and/or (2).
(1) Schedule on a portion of the ignored first gap that does not overlap other gaps. For example, the ignored first gap is partially occupied (overlaps) by the second gap, then the terminal does not perform the task corresponding to the purpose information of the first gap. Correspondingly, the network side device can schedule the terminal on a non-overlapping portion of the first gap.
(2) When the terminal device ignores the first gap because the terminal device sends the first message or measurement report information, the network side device may schedule the terminal based on the ignored first gap.

Further, as a possible implementation, before executing S410, the terminal may also execute at least one of the following (51) and (52).
(51) The terminal device sends the first gap request to the network side device.

The first gap request is used to request the network side device to configure the first gap. Based on this, the first gap request carries at least one of the priority information of the first gap and the purpose information of the first gap (such as Paging purpose), period information, start time information, length information, and the like.

Optionally, the priority of the first gap may be an absolute priority or a relative priority.

For example, for absolute priority, the priority information of the first gap may be MSIM Gap1>MeasGap>MSIM Gap2, or the priority information of the first gap may be high priority, low priority or other specified priorities, and there is no restriction here.

For another example, the relative priority can be: the priority of the first gap relative to the measurement gap: such as high priority and low priority. For example, the first gap with high priority is preferential over the measurement gap; for another example, the measurement gap is preferential over the first gap with low priority.

In addition, the priority information of the first gap may be determined by the terminal device based on the desired purpose information, length information, period information, start time information, or the like of the first gap, which is not limited here.
(52) Receive gap configuration information sent by the network side device.

The gap configuration information (such as RRC reconfiguration information) carries at least one of priority information of the first gap, purpose information of the first gap (such as Paging purpose), period information, start time information, length information, or the like.

In addition, similar to the first gap request, the priority information of the first gap carried in the gap configuration information may also be determined by the network side device based on the purpose information, length information, period information, and start time information of the first gap desired by the terminal device, and the priority of the first gap may be an absolute priority or a relative priority, which will not be described again here.

It can be understood that (51) and (52) may be independent of each other, or the gap configuration information in (52) may be configured based on the first gap request in (51).

For example, when the terminal device is a multi-card terminal and a gap (such as the first gap) needs to be configured in the multi-card terminal to enter other networks for paging monitoring based on the gap, the terminal device can send the first gap request to the network side device to request the network side device to perform gap configuration. Then, after receiving the first gap request, the network side device determines the gap configuration information and sends it to the terminal device.

For another example, when the network side device needs to schedule the terminal device to perform a target task, the network side device can configure gap configuration information according to the target task and send it to the terminal device.

It should be noted that, the gap execution methods 200 to 400 provided by the embodiments of the present application may be performed by a gap execution apparatus, or a control module in the gap execution apparatus for executing the gap execution methods 200 to 400. In the embodiment of the present application, the gap execution methods 200 to 400 being performed by the gap execution apparatus is taken as an example to illustrate the gap execution 30 apparatus provided by the embodiment of the present application.

As shown in FIG. 5, a schematic flowchart of a gap execution method 500 is provided in an exemplary embodiment of the present application. The method 500 can be executed by a network side device, but is not limited thereto. Specifically, the method can be executed by hardware and/or software installed in the network side device. In this embodiment, the method 500 may include at least the following step.
S510: In a case that a first gap overlaps a second gap, the network side device ignores the first gap.

The first gap and the second gap are gaps configured by the network side device for a terminal device.

In an implementation, when the first gap overlaps the second gap, that the network side device ignores the first gap includes: the network side device ignores the first gap when at least one of the following is met: a length of the first gap is shorter than a length of the second gap; a start time of the first gap is later than a start time of the second gap; destination information of the first gap has a lower priority than destination information of the second gap; and the first gap has a lower priority than the second gap.

In another implementation, the method further includes: executing, by the network side device, the step of ignoring the first gap in a case that a first condition is met, where the first condition includes at least one of the following: receiving a first message sent by the terminal device, where the first message includes at least one of an MCG failure message, an SCG failure message and a first indication message, and the first indication message is used to indicate to the network side device that the network side device ignores the first gap; and receiving a measurement report message sent by the terminal device.

In another implementation, the method further includes: in the case that the first gap is ignored, sending, by the network side device, terminal scheduling information to the terminal device.

In another implementation, before the network side device ignores the first gap, the method further includes at least one of the following: receiving, by the network side device, a first gap request sent by the terminal device, where the first gap request carries at least priority information of the first gap and/or purpose information of the first gap; and sending, by the network side device, gap configuration information to the terminal device, where the gap configuration information at least carries priority information of the first gap and/or purpose information of the first gap.

It can be understood that for the implementation process of each implementation given in this embodiment, refer to the relevant descriptions in the foregoing method embodiments 200 to 400, and corresponding technical effects can be achieved. To avoid duplication, they will not be described again here.

Based on the foregoing method embodiments, if the terminal device is a multi-card terminal, for example, the terminal device includes card 1 and card 2, when the terminal device performs paging monitoring based on card 1 and card 2, a paging conflict between card 1 and card 2 may occur, resulting in poor wireless communication performance. In this regard, the embodiments of the present application can adopt methods 1 and/or 2 to process as follows.
Method 1: Method for the non-access stratum (NAS) to process the international mobile subscriber identity offset (IMSI offset)
(1) Each time the UE NAS initiates a TAU or registration request, if the terminal device detects a paging conflict, the UE NAS carries a new IMSI offset value in the TAU or registration request to request the network side device to page based on the new IMSI offset value.
(2) If the terminal does not detect a paging conflict within a period of time, the UE NAS layer carries the saved IMSI offset value in the TAU or registration request, that is, the terminal device continues to use the configured IMSI offset value by default.
(3) If the terminal device does not detect a paging conflict within a period of time, the UE NAS layer does not carry the IMSI offset value in the TAU or registration request, that is, the configured IMSI offset value is deleted.

Method 2: Method for the RRC layer and NAS layer to process an IMSI offset
(1) When the UE initiates a TAU or registration request, the UE NAS layer sends the configured IMSI offset to the UE RRC layer to determine whether the saved IMSI offset is still needed.
(a) If the UE RRC feedback requires an IMSI offset value, the UE NAS carries, in the TAU or registration request, the IMSI offset saved by the UE.

If the core network detects that the IMSI offset value has not changed, it continues to use the current IMSI offset value, that is, the IMSI offset will not be changed.
(b) If the UE RRC feedback does not require an IMSI offset value, the UE NAS layer does not carry the IMSI offset when initiating a TAU or registration request, that is, requests to delete the configured IMSI offset.
(2) Once the UE NAS receives the accepted IMSI offset, the UE NAS sends it to the UE RRC. When the IMSI offset needs to be updated, the UE RRC layer reports the recommended IMSI offset value to the UE NAS layer.

The case of updating the IMSI offset includes at least one of the following (21) and (22).
(21) There is a paging conflict in the currently saved IMSI offset, and the IMSI offset needs to be reconfigured.
(22) It is indicated that the terminal no longer needs the currently saved IMSI offset value.

For example, if the UE RRC sets the recommended IMSI offset to a non-zero value, the UE NAS carries the new requested IMSI offset in the TAU or registration request. If the UE RRC sets the recommended IMSI offset to 0, the UE NAS layer does not carry any IMSI offset when initiating a TAU or registration request.

Based on the method 1 and/or method 2, the paging conflict problem existing on the multi-card terminal can be effectively solved, ensuring wireless communication performance.

As shown in FIG. 6, a schematic structural diagram of a gap execution apparatus 600 is provided in an exemplary embodiment of the present application. The apparatus 600 may include: a first execution module 610, configured to: in a case that a first gap overlaps with a second gap or a measurement occasion corresponding to a first task, perform first processing on the first gap; where the terminal device is configured with at least one gap, the first gap and the second gap belong to the at least one gap, and the first processing includes ignoring the first gap or using the first gap.

Optionally, the apparatus 600 may further include a determination module, configured to determine whether the first gap overlaps the second gap or the measurement occasion corresponding to the first task.

Optionally, when the first gap overlaps the second gap, the first execution module 610 is configured to perform any one of the following: using the first gap and ignoring the second gap; using the first gap and using the second gap after the first gap ends; using the first gap and using the second gap before the first gap begins; using a third gap and using the second gap, where the third gap is a portion of the first gap that does not overlap the second gap; using the second gap within the first duration and using the first gap within the second duration; where the first duration includes a first number of time units that are earlier in the first gap, and the second duration includes time units in the first gap other than the first number of time units; and using the second gap within a third duration and using the first gap within a fourth duration, where the third duration includes a second number of time units that are later in the first gap, and the fourth duration includes time units in the first gap other than the second number of time units.

Optionally, the first execution module 610 uses the first gap and ignores the second gap when at least one of the following is met: the first gap has a higher priority than the second gap; destination information of the first gap has a higher priority than destination information of the second gap; a length of the first gap is longer than a length of the second gap; and a start time of the first gap is earlier than a start time of the second gap.

Optionally, the first execution module 610 ignores the first gap when the first gap overlaps the second gap and at least one of the following is met: a length of the first gap is shorter than a length of the second gap; a start time of the first gap is later than a start time of 5 the second gap; destination information of the first gap has a lower priority than destination information of the second gap; and the first gap has a lower priority than the second gap.

Optionally, in the case that the first gap overlaps the measurement occasion corresponding to the first task, the first execution module 610 is configured to perform any one of the following: using the first gap and ignoring the first task; using the first gap and executing 10 the first task after the first gap ends; and using the first gap and executing the first task before the first task begins.

Optionally, in a case that the first task is an RRM measurement task and/or the terminal device ignores a measurement gap, a measurement period corresponding to the RRM measurement task is a first length, the first length is obtained by extending a length of the 15 measurement period by a length of at least one first gap, and the measurement gap is associated with a measurement occasion corresponding to the RRM measurement task.

Optionally, the first execution module 610 is also configured to execute the step of ignoring the first gap in a case that a first condition is met, where the first condition includes at least one of the following: master cell group MCG radio link failure; secondary cell group SCG 20 radio link failure; a first timer starts running, where the first timer is configured to monitor whether a radio link fails; the terminal device sends a first message, where the first message includes at least one of an MCG failure message, an SCG failure message and a first indication message, and the first indication message is used to indicate to the network side device that the terminal device ignores the first gap; the terminal device initiates an MCG failure information 25 process; the terminal device initiates an SCG failure information process; and the terminal device sends a measurement report message.

Optionally, the first execution module 610 is configured to ignore the first gap within a fifth duration after sending the measurement report message.

Optionally, the first execution module 610 is configured to perform any one of the 30 following: releasing configuration information corresponding to the first gap; ignoring the fourth gap, where the fourth gap is the first gap that overlaps the second gap or the measurement occasion corresponding to the first task, or the fourth gap is the first gap when the first condition is met; and ignoring the fourth gap and at least one first gap located after the fourth gap. Optionally, the first execution module 610 is also configured to: in a case that the first gap is used, cancel monitoring of a monitoring occasion of a power saving signal, where the power saving signal at least includes a DCP signal and/or a wake-up signal.

Optionally, the apparatus 600 further includes: a first transceiver module 610, configured to: in the case that the first gap is ignored, receive terminal scheduling information sent by the network side device during the first gap.

Optionally, the first transceiver module 610 is also configured to perform at least one of the following: sending a first gap request to the network side device, where the first gap request carries at least priority information of the first gap and/or purpose information of the first gap; and receiving gap configuration information sent by the network side device, where the gap configuration information at least carries priority information of the first gap and/or purpose information of the first gap.

In this embodiment, in the case that the first gap overlaps the second gap or the measurement occasion corresponding to the first task, the first gap is used or the first gap is ignored, thereby providing a gap processing mechanism in the scenario where gaps overlap each other or a gap overlaps the measurement occasion corresponding to the first task. This enables the terminal device to clarify its own behavior and perform gap processing, effectively ensuring the quality of wireless communication.

It should be noted that the gap execution apparatus 600 in the embodiment of the present application may be an apparatus, an apparatus with an operating system or an electronic device, or may be a component, an integrated circuit, or a chip in a terminal. The apparatus or electronic device may be a mobile terminal, or a non-mobile terminal. For example, the mobile terminal may include but is not limited to the types of the foregoing listed terminal 11, and the non-mobile terminal may be a server, a network attached storage (NAS), a personal computer (PC), a television (TV), an automated teller machine, or a self-service machine. This is not specifically limited in this embodiment of this application.

The gap execution apparatus 600 according to an embodiments of the present disclosure can implement the processes in the method embodiments in FIG. 2 to FIG. 4, and achieve the same technical effect. To avoid duplication, details are not described herein again.

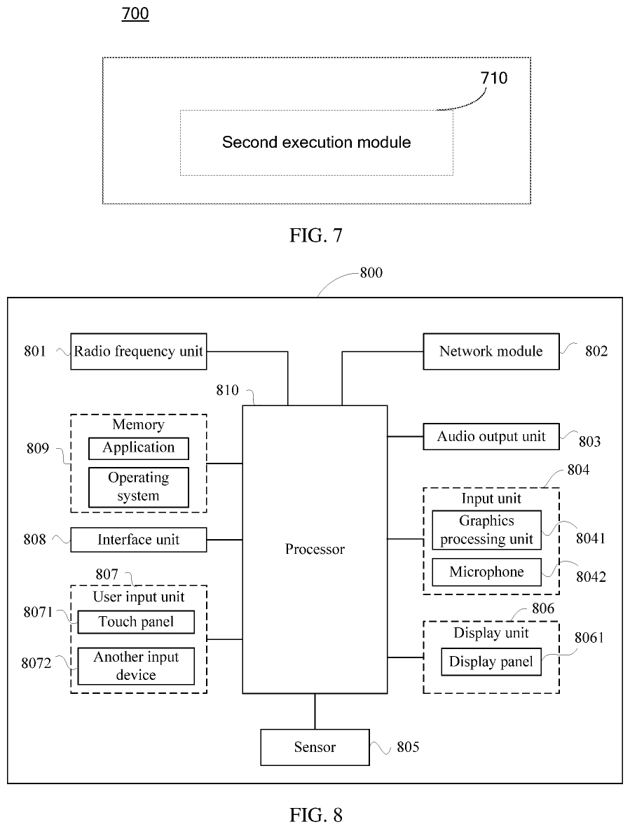

As shown in FIG. 7, a schematic structural diagram of a gap execution apparatus 700 is provided in an exemplary embodiment of the present application. The apparatus 700 includes: a second execution module 710, configured to: in a case that a first gap overlaps a second gap, ignore the first gap; where the first gap and the second gap are gaps configured by the network side device for a terminal device.

Optionally, the apparatus 700 may further include a configuration module, configured to configure at least one gap for the terminal device, where the first gap and the second gap belong to the at least one gap.

Optionally, the second execution module 710 is configured to ignore the first gap when at least one of the following is met: a length of the first gap is shorter than a length of the second gap; a start time of the first gap is later than a start time of the second gap; destination information of the first gap has a lower priority than destination information of the second gap; and the first gap has a lower priority than the second gap.

Optionally, the second execution module 710 is configured to execute the step of ignoring the first gap in a case that a first condition is met, where the first condition includes at least one of the following: receiving a first message sent by the terminal device, where the first message includes at least one of an MCG failure message, an SCG failure message and a first indication message, and the first indication message is used to indicate to the network side device that the network side device ignores the first gap; and receiving a measurement report message sent by the terminal device.

Optionally, the apparatus 700 further includes: a second transceiver module 720, configured to: in the case that the first gap is ignored, send terminal scheduling information to the terminal device.

Optionally, the second transceiver module 720 is also configured to perform at least one of the following: receiving a first gap request sent by the terminal device, where the first gap request carries at least priority information of the first gap and/or purpose information of the first gap; and sending gap configuration information to the terminal device, where the gap configuration information at least carries priority information of the first gap and/or purpose information of the first gap.

The gap execution apparatus 700 according to an embodiments of the present disclosure can implement the processes in the method embodiments in FIG. 5, and achieve the same technical effect. To avoid duplication, details are not described herein again.

An embodiment of the present application also provides a terminal, including a processor and a communication interface. The communication interface is coupled to the processor. The processor is configured to run programs or instructions to implement steps in method embodiments 200 to 400 and achieve corresponding technical effects. This terminal embodiment corresponds to the foregoing method embodiment on the terminal side. Each implementation process and implementation of the foregoing method embodiment may be applicable to this terminal embodiment, and a same technical effect can be achieved. Specifically, FIG. 8 is a schematic diagram of a hardware structure of a terminal according to an embodiment of this application.

A terminal 800 includes but is not limited to at least a part of components such as a radio frequency unit 801, a network module 802, an audio output unit 803, an input unit 804, a sensor 805, a display unit 806, a user input unit 807, an interface unit 808, a memory 809, and a processor 810.

A person skilled in the art can understand that the terminal 800 may further include a power supply (such as a battery) that supplies power to each component. The power supply may be logically connected to the processor 810 by using a power supply management system, to implement functions such as charging and discharging management, and power consumption management by using the power supply management system. The terminal structure shown in FIG. 8 constitutes no limitation on the terminal, and the terminal may include more or fewer components than those shown in the figure, or combine some components, or have different component arrangements. Details are not described herein.

It should be understood that in the embodiments of this application, the input unit 804 may include a graphics processing unit (GPU) 8041 and a microphone 8042, and the graphics processing unit 8041 processes image data of a still picture or video obtained by an image capture apparatus (such as a camera) in a video capture mode or an image capture mode. The display unit 806 may include a display panel 8061. Optionally, the display panel 8061 may be configured in a form such as a liquid crystal display or an organic light-emitting diode. The user input unit 807 includes a touch panel 8071 and another input device 8072. The touch panel 8071 is also referred to as a touchscreen. The touch panel 8071 may include two parts: a touch detection apparatus and a touch controller. The another input device 8072 may include but is not limited to a physical keyboard, a functional button (such as a volume control button or a power on/off button), a trackball, a mouse, and a joystick. Details are not described herein.

In this embodiment of this application, the radio frequency unit 801 receives downlink data from a network side device and then sends the downlink data to the processor 810 for processing; and sends uplink data to the network side device. Usually, the radio frequency unit 801 includes but is not limited to an antenna, at least one amplifier, a transceiver, a coupler, a low noise amplifier, a duplexer, and the like.

The memory 809 may be configured to store a software program or an instruction and various data. The memory 809 may mainly include a program or instruction storage area and a data storage area. The program or instruction storage area may store an operating system, and an application or an instruction required by at least one function (for example, a sound playing function or an image playing function). In addition, the memory 809 may include a high-speed random access memory, and may further include a non-volatile memory. The non-volatile memory may be a read-only memory (ROM), a programmable read-only memory (Programmable ROM, PROM), an erasable programmable read-only memory (Erasable PROM, EPROM), an electrically erasable programmable read-only memory (Electrically EPROM, EEPROM), or a flash memory, for example, at least one disk storage device, a flash memory device, or another non-volatile solid-state storage device.

The processor 810 may include one or more processing units. Optionally, an application processor and a modem processor may be integrated into the processor 810. The application processor mainly processes an operating system, a user interface, an application, an instruction, or the like. The modem processor mainly processes wireless communication, for example, a baseband processor. It can be understood that, alternatively, the modem processor may not be integrated into the processor 810.

The processor 810 is configured to: in a case that a first gap overlaps with a second gap or a measurement occasion corresponding to a first task, perform first processing on the first gap; where the terminal device is configured with at least one gap, the first gap and the second gap belong to the at least one gap, and the first processing includes ignoring the first gap or using the first gap.

Optionally, when the first gap overlaps the second gap, the processor 810 is configured to perform any one of the following: using the first gap and ignoring the second gap; using the first gap and using the second gap after the first gap ends; using the first gap and using the second gap before the first gap begins; using a third gap and using the second gap, where the third gap is a portion of the first gap that does not overlap the second gap; using the second gap within the first duration and using the first gap within the second duration; where the first duration includes a first number of time units that are earlier in the first gap, and the second duration includes time units in the first gap other than the first number of time units; and using the second gap within a third duration and using the first gap within a fourth duration, where the third duration includes a second number of time units that are later in the first gap, and the fourth duration includes time units in the first gap other than the second number of time units.

Optionally, the processor 810 uses the first gap and ignores the second gap when at least one of the following is met: the first gap has a higher priority than the second gap; destination information of the first gap has a higher priority than destination information of the second gap; a length of the first gap is longer than a length of the second gap; and a start time of the first gap is earlier than a start time of the second gap.

Optionally, the processor 810 ignores the first gap when the first gap overlaps the second gap and at least one of the following is met: a length of the first gap is shorter than a length of the second gap; a start time of the first gap is later than a start time of the second gap; destination information of the first gap has a lower priority than destination information of the second gap; and the first gap has a lower priority than the second gap.

Optionally, in the case that the first gap overlaps the measurement occasion corresponding to the first task, the processor 810 is configured to perform any one of the following: using the first gap and ignoring the first task; using the first gap and executing the first task after the first gap ends; and using the first gap and executing the first task before the first task begins.

Optionally, in a case that the first task is an RRM measurement task and/or the terminal device ignores a measurement gap, a measurement period corresponding to the RRM measurement task is a first length, the first length is obtained by extending a length of the measurement period by a length of at least one first gap, and the measurement gap is associated with a measurement occasion corresponding to the RRM measurement task.

Optionally, the processor 810 is also configured to execute the step of ignoring the first gap in a case that a first condition is met, where the first condition includes at least one of the following: master cell group MCG radio link failure; secondary cell group SCG radio link failure; a first timer starts running, where the first timer is configured to monitor whether a radio link fails; the terminal device sends a first message, where the first message includes at least one of an MCG failure message, an SCG failure message and a first indication message, and the first indication message is used to indicate to the network side device that the terminal device ignores the first gap; the terminal device initiates an MCG failure information process; the terminal device initiates an SCG failure information process; and the terminal device sends a measurement report message.

Optionally, the processor 810 is configured to ignore the first gap within a fifth duration after sending the measurement report message.

Optionally, the processor 810 is configured to perform any one of the following: releasing configuration information corresponding to the first gap; ignoring the fourth gap, where the fourth gap is the first gap that overlaps the second gap or the measurement occasion corresponding to the first task, or the fourth gap is the first gap when the first condition is met; and ignoring the fourth gap and at least one first gap located after the fourth gap.

Optionally, the processor 810 is also configured to: in a case that the first gap is used, cancel monitoring of a monitoring occasion of a power saving signal, where the power saving signal at least includes a DCP signal and/or a wake-up signal.

Optionally, the radio frequency unit 801 is configured to: in the case that the first gap is ignored, receive terminal scheduling information sent by the network side device during the first gap.

Optionally, the radio frequency unit 801 is also configured to perform at least one of the following: sending a first gap request to the network side device, where the first gap request carries at least priority information of the first gap and/or purpose information of the first gap; and receiving gap configuration information sent by the network side device, where the gap configuration information at least carries priority information of the first gap and/or purpose information of the first gap.

In this embodiment, in the case that the first gap overlaps the second gap or the measurement occasion corresponding to the first task, the first gap is used or the first gap is ignored, thereby providing a gap processing mechanism in the scenario where gaps overlap each other or a gap overlaps the measurement occasion corresponding to the first task. This enables the terminal device to clarify its own behavior and perform gap processing, effectively ensuring the quality of wireless communication.

An embodiment of the present application further provides a readable storage medium. The readable storage medium stores a program or an instruction, and when the program or the instruction is executed by a processor, the various processes of the method embodiments 200 to 500 is performed and the same technical effects can be achieved. To avoid repetition, details are not described herein again.

The processor is a processor in the terminal in the foregoing embodiment. The readable storage medium includes computer-readable storage media, such as computer read-only memory (ROM).

An embodiment of the present application also provides a network side device, including a processor and a communication interface. The communication interface is coupled to the processor. The processor is configured to run programs or instructions to implement steps of the method described in method embodiment 500. This network side device embodiment corresponds to the foregoing method embodiment on the network side device. Each implementation process and implementation of the foregoing method embodiment may be applicable to this network side device embodiment, and a same technical effect can be achieved.

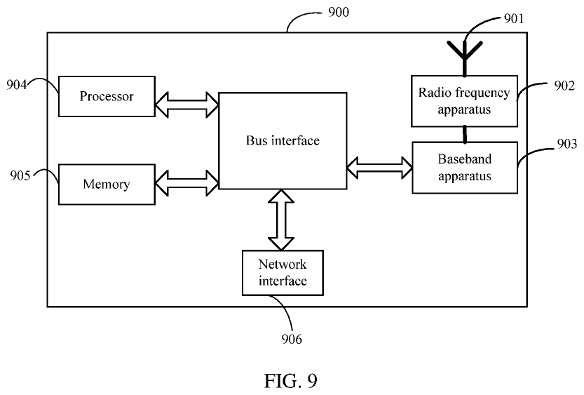

Specifically, an embodiment of this application further provides a network side device. As shown in FIG. 9, a network device 900 includes an antenna 901, a radio frequency apparatus 902, and a baseband apparatus 903. The antenna 901 is connected to the radio frequency apparatus 902. In an uplink direction, the radio frequency apparatus 902 receives information by using the antenna 901, and sends the received information to the baseband apparatus 903 for processing. In a downlink direction, the baseband apparatus 903 processes to-be-sent information, and sends the information to the radio frequency apparatus 902. The radio frequency apparatus 902 processes the received information and then sends the information by using the antenna 901.

The frequency band processing apparatus may be located in the baseband apparatus 903. The method performed by the network side device in the foregoing embodiment may be implemented in the baseband apparatus 903. The baseband apparatus 903 includes a processor 904 and a memory 905.

The baseband apparatus 903 may include, for example, at least one baseband board, where a plurality of chips are disposed on the baseband board. As shown in FIG. 9, one chip is, for example, the processor 904, which is connected to the memory 905, so as to invoke a program in the memory 905 to perform operations of the network device shown in the foregoing method embodiment.

The baseband apparatus 903 may further include a network interface 906, configured to exchange information with the radio frequency apparatus 902, where the interface is, for example, a common public radio interface (CPRI).

Specifically, the network side device in this embodiment of the present invention further includes an instruction or a program that is stored in the memory 905 and that can be run on the processor 904. The processor 904 invokes the instruction or the program in the memory 905 to perform the method performed by the modules shown in FIG. 7, and a same technical effect is achieved. To avoid repetition, details are not described herein again.

An embodiment of the present application further provides a chip, the chip includes a processor and a communication interface, the communication interface is coupled to the processor, and the processor is configured to run the program or instruction of the network side device to realize each process of the method embodiments 200 to 500, and can achieve the same technical effect. To avoid repetition, details are not repeated herein.

It should be understood that the chip mentioned in this embodiment of this application may also be referred to as a system-level chip, a system chip, a chip system, or an on-chip system chip.

The embodiments of the present application further provide a computer program product, the computer program product includes a processor, a memory, and a program or an instruction stored in the memory and executable on the processor, when the program or the instruction is executed by the processor, each process of the method embodiments 200 to 500 can be realized, and the same technical effect can be achieved. To avoid repetition, details are not repeated herein.

It should be noted that in this specification, the term “include”, “comprise”, or any other variant is intended to cover non-exclusive inclusion, so that a process, method, article, or apparatus that includes a series of elements includes not only those elements but also other elements that are not explicitly listed, or includes elements inherent to such a process, method, article, or apparatus. An element limited by “includes a . . . ” does not, without more constraints, preclude the presence of additional identical elements in the process, method, article, or apparatus that includes the element. In addition, it should be noted that the scope of the method and the apparatus in the embodiments of this application is not limited to performing functions in an illustrated or discussed sequence, and may further include performing functions in a basically simultaneous manner or in a reverse sequence according to the functions concerned. For example, the described method may be performed in an order different from that described, and the steps may be added, omitted, or combined. In addition, features described with reference to some examples may be combined in other examples.

Based on the descriptions of the foregoing implementations, a person skilled in the art may clearly understand that the method in the foregoing embodiment may be implemented by software in addition to a necessary universal hardware platform or by hardware only. In most circumstances, the former is a preferred implementation. Based on such an understanding, the technical solutions of this application essentially, or the part contributing to the prior art may be implemented in a form of a computer software product. The computer software product is stored in a storage medium (for example, a ROM/RAM, a magnetic disk, or a compact disc), and includes a plurality of instructions for instructing a terminal (which may be a mobile phone, a computer, a server, an air conditioner, a network device, or the like) to perform the method described in the embodiments of this application.

The embodiments of this application are described above with reference to the accompanying drawings, but this application is not limited to the above specific implementations, and the above specific implementations are only illustrative and not restrictive. Under the enlightenment of this application, those of ordinary skill in the art can make many forms without departing from the purpose of this application and the protection scope of the claims, all of which fall within the protection of this application.

What is claimed is:

1. A gap execution method, comprising:
in a case that a first gap overlaps a second gap or a measurement occasion corresponding to a first task, performing, by a terminal device, first processing on the first gap;
wherein the terminal device is configured with at least one gap, the first gap and the second gap belong to the at least one gap, and the first processing comprises ignoring the first gap or using the first gap.

2. The method according to claim 1, wherein in a case that the first gap overlaps the second gap, using, by the terminal device, the first gap comprises any one of the following:
using the first gap and ignoring the second gap;
using the first gap and using the second gap after the first gap ends;
using the first gap and using the second gap before the first gap begins;
using a third gap and using the second gap, wherein the third gap is a portion of the first gap that does not overlap the second gap;
using the second gap within the first duration and using the first gap within the second duration; wherein the first duration comprises a first number of time units that are earlier in the first gap, and the second duration comprises time units in the first gap other than the first number of time units; and
using the second gap within a third duration and using the first gap within a fourth duration, wherein the third duration comprises a second number of time units that are later in the first gap, and the fourth duration comprises time units in the first gap other than the second number of time units.

3. The method according to claim 2, wherein the using the first gap and ignoring the second gap comprises:
the terminal uses the first gap and ignores the second gap in a case that at least one of the following is met:
the first gap has a higher priority than the second gap;
destination information of the first gap has a higher priority than destination information of the second gap;
a length of the first gap is longer than a length of the second gap; and
a start time of the first gap is earlier than a start time of the second gap.

4. The method according to claim 1, wherein in a case that the first gap overlaps the second gap, ignoring, by the terminal device, the first gap comprises:
the terminal device ignores the first gap in a case that at least one of the following is met:
a length of the first gap is shorter than a length of the second gap;
a start time of the first gap is later than a start time of the second gap;
destination information of the first gap has a lower priority than destination information of the second gap; and
the first gap has a lower priority than the second gap.

5. The method according to claim 1, wherein in a case that the first gap overlaps the measurement occasion corresponding to the first task, using, by the terminal device, the first gap comprises any one of the following:
using the first gap and ignoring the first task;
using the first gap and executing the first task after the first gap ends; and
using the first gap and executing the first task before the first task begins.

6. The method according to claim 5, wherein in a case that the first task is an RRM measurement task and/or the terminal device ignores a measurement gap, a measurement period corresponding to the RRM measurement task is a first length, the first length is obtained by extending a length of the measurement period by a length of at least one first gap, and the measurement gap is associated with a measurement occasion corresponding to the RRM measurement task.

7. The method according to claim 1, wherein the method further comprises:
in a case that a first condition is met, performing, by the terminal device, the step of ignoring the first gap, wherein the first condition comprises at least one of the following:
master cell group (MCG) radio link failure;
secondary cell group (SCG) radio link failure;
a first timer starts running, wherein the first timer is configured to monitor whether a radio link fails;
the terminal device sends a first message, wherein the first message comprises at least one of an MCG failure message, an SCG failure message and a first indication message, and the first indication message is used to indicate to the network side device that the terminal device ignores the first gap;
the terminal device initiates an MCG failure information process;
the terminal device initiates an SCG failure information process; and
the terminal device sends a measurement report message.

8. The method according to claim 7, wherein in a case that a measurement report message is sent, ignoring the first gap comprises:
ignoring the first gap within a fifth duration after sending the measurement report message.

9. The method according to claim 1, wherein ignoring the first gap comprises any one of the following:
releasing configuration information corresponding to the first gap;
ignoring the fourth gap, wherein the fourth gap is the first gap that overlaps the second gap or the measurement occasion corresponding to the first task, or the fourth gap is the first gap when the first condition is met; and
ignoring the fourth gap and at least one first gap located after the fourth gap;
and/or,
wherein the method further comprises:
in a case that the first gap is used, canceling, by the terminal device, monitoring of a monitoring occasion of a power saving signal, wherein the power saving signal at least comprises a DCP signal and/or a wake-up signal;
and/or,
wherein the method further comprises:
in a case that the first gap is ignored, receiving, by the terminal device, terminal scheduling information sent by the network side device during the first gap;
and/or,
wherein before performing the first processing on the first gap, the method further comprises at least one of the following:
sending, by the terminal device, a first gap request to the network side device, wherein the first gap request carries at least priority information of the first gap and/or purpose information of the first gap; and
receiving gap configuration information sent by the network side device, wherein the gap configuration information at least carries priority information of the first gap and/or purpose information of the first gap.

10. A gap execution method, comprising:
ignoring, by the network side device, the first gap in a case that a first gap overlaps a second gap;
wherein the first gap and the second gap are gaps configured by the network side device for a terminal device.

11. The method according to claim 10, wherein the ignoring, by the network side device, the first gap in a case that a first gap overlaps a second gap comprises:
the network side device ignores the first gap in a case that at least one of the following is met:
a length of the first gap is shorter than a length of the second gap;
a start time of the first gap is later than a start time of the second gap;
destination information of the first gap has a lower priority than destination information of the second gap; and
the first gap has a lower priority than the second gap;
and/or,
wherein the method further comprises:
in a case that a first condition is met, performing, by the network side device, the step of ignoring the first gap, wherein the first condition comprises at least one of the following:
receiving a first message sent by the terminal device, wherein the first message comprises at least one of an MCG failure message, an SCG failure message and a first indication message, and the first indication message is used to indicate to the network side device that the network side device ignores the first gap; and
receiving a measurement report message sent by the terminal device.

12. The method according to claim 10, wherein the method further comprises:
in the case that the first gap is ignored, sending, by the network side device, terminal scheduling information to the terminal device;
and/or,
wherein before the network side device ignores the first gap, the method further comprises at least one of the following:
receiving, by the network side device, a first gap request sent by the terminal device, wherein the first gap request carries at least priority information of the first gap and/or purpose information of the first gap; and
sending, by the network side device, gap configuration information to the terminal device, wherein the gap configuration information at least carries priority information of the first gap and/or purpose information of the first gap.

13. A terminal, comprising a processor, a memory, and a program or instruction stored on the memory and executable on the processor, wherein when the program or instruction is executed by the processor, following steps are implemented:
in a case that a first gap overlaps a second gap or a measurement occasion corresponding to a first task, performing first processing on the first gap;
wherein the terminal is configured with at least one gap, the first gap and the second gap belong to the at least one gap, and the first processing comprises ignoring the first gap or using the first gap.

14. The terminal according to claim 13, wherein in a case that the first gap overlaps the second gap, using the first gap comprises any one of the following:
using the first gap and ignoring the second gap;
using the first gap and using the second gap after the first gap ends;
using the first gap and using the second gap before the first gap begins;
using a third gap and using the second gap, wherein the third gap is a portion of the first gap that does not overlap the second gap;
using the second gap within the first duration and using the first gap within the second duration; wherein the first duration comprises a first number of time units that are earlier in the first gap, and the second duration comprises time units in the first gap other than the first number of time units; and
using the second gap within a third duration and using the first gap within a fourth duration, wherein the third duration comprises a second number of time units that are later in the first gap, and the fourth duration comprises time units in the first gap other than the second number of time units.

15. The terminal according to claim 14, wherein the using the first gap and ignoring the second gap comprises:
using the first gap and ignoring the second gap in a case that at least one of the following is met:
the first gap has a higher priority than the second gap;
destination information of the first gap has a higher priority than destination information of the second gap;
a length of the first gap is longer than a length of the second gap; and
a start time of the first gap is earlier than a start time of the second gap.

16. The terminal according to claim 13, wherein in a case that the first gap overlaps the second gap, ignoring the first gap comprises:
ignoring the first gap in a case that at least one of the following is met:
a length of the first gap is shorter than a length of the second gap;
a start time of the first gap is later than a start time of the second gap;
destination information of the first gap has a lower priority than destination information of the second gap; and
the first gap has a lower priority than the second gap.

17. The terminal according to claim 13, wherein in a case that the first gap overlaps the measurement occasion corresponding to the first task, using the first gap comprises any one of the following:
using the first gap and ignoring the first task;
using the first gap and executing the first task after the first gap ends; and
using the first gap and executing the first task before the first task begins.

18. The terminal according to claim 17, wherein in a case that the first task is an RRM measurement task and/or the terminal device ignores a measurement gap, a measurement period corresponding to the RRM measurement task is a first length, the first length is obtained by extending a length of the measurement period by a length of at least one first gap, and the measurement gap is associated with a measurement occasion corresponding to the RRM measurement task.

19. The terminal according to claim 13, wherein when the program or instruction is executed by the processor, following steps are further implemented:
in a case that a first condition is met, performing the step of ignoring the first gap, wherein the first condition comprises at least one of the following:
master cell group (MCG) radio link failure;
secondary cell group (SCG) radio link failure;
a first timer starts running, wherein the first timer is configured to monitor whether a radio link fails;
the terminal device sends a first message, wherein the first message comprises at least one of an MCG failure message, an SCG failure message and a first indication message, and the first indication message is used to indicate to the network side device that the terminal device ignores the first gap;
the terminal device initiates an MCG failure information process;
the terminal device initiates an SCG failure information process; and
the terminal device sends a measurement report message.

20. A network side device, comprising a processor, a memory, and a program or instruction stored on the memory and executable on the processor, wherein when the program or instruction is executed by the processor, steps of the gap execution method according to claim 10 are implemented.
